(19) United States
(12) Patent Application Publication
(10) Pub. No.: US 2011/0234493 A1
(43) Pub. Date: Sep. 29, 2011

(54) System and method for interacting with display floor using multi-touch sensitive surround surfaces

(75) Inventors: Donald Kravits, Glendale, CA (US); Gregory Butkus, La Verne, CA (US); Karen S. Leung, South Pasadena, CA (US); Peter Ricci, Deland, FL (US); Marcelyn J. Floyd, Bay Lake, FL (US); Charles L. Bueche, Austin, TX (US)

(73) Assignee: DISNEY ENTERPRISES, INC., Burbank, CA (US)

(21) Appl. No.: 12/932,466

(22) Filed: Feb. 25, 2011

Related U.S. Application Data
(60) Provisional application No. 61/318,117, filed on Mar. 26, 2010.

(51) Int. Cl. G06F 3/033; G06F 3/044; G06F 3/041

(52) U.S. Cl. 345/160; 345/174; 345/173

(57) ABSTRACT

There is provided a system and method for the interactive display floor with multi-touch surround surfaces that is integrated with an interactive computer system. There is provided a system comprising an interactive video floor, a sensitized peripheral surface, an interactive computer and video system. When the user makes contact with sensitized peripheral surface, digital input data is transmitted to interactive computer. After analyzing the digital input data, the interactive computer sends digital output data back to interactive video floor through video system, and back to sensitized peripheral surface. The interactive video floor redisplays its graphics based on the content of the digital output data, and the sensitized peripheral surface reconfigures itself with respect to the information within digital output data.

### RELATED APPLICATIONS

This application claims priority to U.S. Provisional Application No. 61/318,117, filed on Mar. 26, 2010, which is hereby incorporated by reference in its entirety.

### BACKGROUND OF THE INVENTION

1. Field of the Invention

The present invention relates generally to an interactive display floor. More particularly, the present invention relates to an interactive display floor controlled by multi-touch sensitive surround surfaces.

2. Background Art

Interactive display floors, such as those used in electronic advertisements and multiplayer videogames, are well known in the art. Interactive display floors are widely used because they allow users to alter graphical contents displayed through the display floors by simply moving across the display floor. An interactive video floor can alter its graphical displays when it senses a physical presence or motion of objects on its surface. When an object's physical presence or motion is detected, the interactive display floor translates this detection into software commands that alter the graphical displays on the display floor. Given the advancement of modern hardware and software capabilities, display floor may be designed to be very sensitive to any minute differences in movement or pressure above display floor. For example, running or walking on a display floor may trigger two different graphical responses. In another example, different weight pressure applied onto display floor may trigger different graphical responses. It is precisely display floors' real time reaction to user's presence and motion that may engage the user's attention towards the displayed contents on the display floor.

One well-known usage of an interactive display floor is the display of a body of virtual water. The interactive display floor consists of one or more video display screens physically pieced together to display the entire body of calm water. A user may stand, walk, or run across the display floor. As a result of this movement, the body of virtual water reacts to the user's movements by generating virtual ripples and splashes, all in realistic fashion. Once the user's movements end, the ripples and splashes eventually subside and the virtual water returns to stillness.

Another popular and simple example is the display of a virtual soccer ball on a virtual soccer field in an interactive display floor. This example creates a videogame like interactive environment with users cooperating with each other. In this example, multiple users may move across the display floor and kick at open space above the virtual soccer ball. Interactive display floor detects the kicking motion and causes the virtual soccer ball to react as if it is being kicked. Two users may kick the graphical soccer ball between each other. Multiple users may attempt to compete with each other by kicking the virtual soccer ball towards a virtual goal.

However, there are several drawbacks when multiple individuals are required to interact with each other on the interactive display floor. When multiple individuals are moving across the display floor, physical contacts may occur and such physical contacts can disrupt a user's graphical interaction. Such physical contacts may be occasionally severe enough to cause physical pain and suffering to the users involved. Therefore, undesirable physical contact resulting from multiple individuals moving across a display floor is a substantial drawback.

Another drawback when multiple users moving across the display floor is the obstruction to users' views by other users. The interactive display floor generally lies flat on the ground. A user's vision of the interactive display floor can be easily obstructed when other people are moving within the user's field of vision. When a user's field of vision is obstructed, such obstruction may detract from the user's overall enjoyment of interacting with the display floor.

Moreover, while some games may require individuals to move across the display floor, many games do not require any individual to actually move across the display floor. In fact, such movement across the display floor may greatly disrupt the nature of the game.

Accordingly, there is a need to overcome the drawbacks and deficiencies in the art by providing an environment for competitive or cooperative play on a video floor when individuals are not required to move across the interactive display floor.

### SUMMARY OF THE INVENTION

There are provided systems and methods for interacting with display floor using multi-touch sensitive surround surfaces, substantially as shown in and/or described in connection with at least one of the figures, as set forth more completely in the claims.

### BRIEF DESCRIPTION OF THE DRAWINGS

The features and advantages of the present invention will become more readily apparent to those ordinarily skilled in the art after reviewing the following detailed description and accompanying drawings, wherein:

FIG. 1 presents a diagram of a system for implementing the interacting with display floor using multi-touch sensitive surround surfaces, according to one embodiment of the present invention;

FIG. 2 presents a diagram of three instances of the interacting with display floor using multi-touch sensitive surround surfaces, according to one embodiment of the present invention; and

FIG. 3 shows a flowchart describing the steps, according to one embodiment of the present invention, by which the interacting with display floor using multi-touch sensitive surround surfaces may be provided.

### DETAILED DESCRIPTION OF THE INVENTION

The present application is directed to a system and method for the interacting with display floor using multi-touch surround surfaces. The following description contains specific information pertaining to the implementation of the present invention. One skilled in the art will recognize that the present invention may be implemented in a manner different from that specifically discussed in the present application. Moreover, some of the specific details of the invention are not discussed in order not to obscure the invention. The specific details not described in the present application are within the knowledge of a person of ordinary skill in the art. The drawings in the present application and their accompanying detailed description are directed to merely exemplary embodiments in the invention. To maintain brevity, other embodiments of the invention, which use the principles of the present invention, are not specifically described in the present application and are not specifically illustrated by the present drawings.

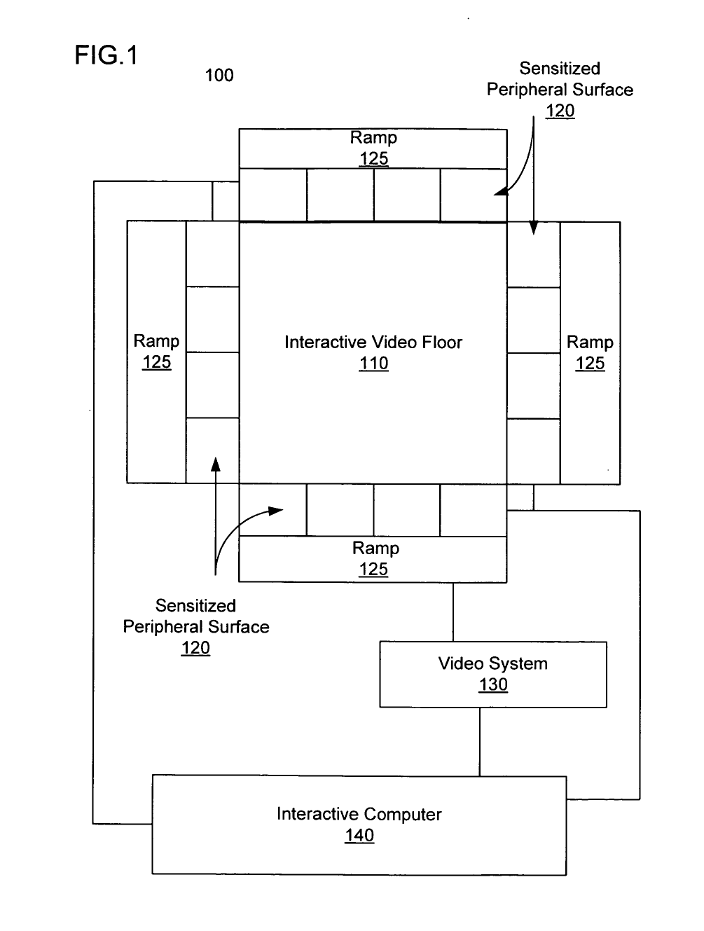

FIG. 1 presents a diagram of a system for implementing the interacting with display floor using multi-touch sensitive surround surfaces, according to one embodiment of the present invention. Diagram 100 of FIG. 1 includes an interactive video floor 110, sensitized peripheral surfaces 120, ramp 125, video system 130, and interactive computer system 140.

In one embodiment of the invention as shown in FIG. 1, interactive video floor 110 may comprise of one or more LCD video screens. When interactive video floor 110 comprises multiple LCD video screens, the LCD video screens may be pieced together to form a single display floor. In other embodiments of the invention, interactive video floor 110 may comprise any type of display monitor and multiple types of monitors may form interactive video floor 110. Interactive video floor 110 may respond with real time graphical displays to an individual's movement across the surface of sensitized peripheral surface 120.

In one embodiment of the invention as shown in FIG. 1, sensitized peripheral surface 120 may surround the edges of interactive video floor 110, and sensitized peripheral surface 120 may be attached to interactive video floor 110. To interact with interactive video floor 110, an individual may stand or move on top of sensitized peripheral surface 120. Motions such as moving that individual's feet across the surface of sensitized peripheral surface 120 may cause real time changes to the graphical display within interactive video floor 110, depending on the interactive graphical program or videogame being executed in interactive computer 140. Sensitized peripheral surface 120 may comprise capacitive multi-touch LED display panel, or Sensacell TouchArray System. Sensitized peripheral surface 120 may detect any type of movement, such as feet being dragged or lifted off of the surface of sensitized peripheral surface 120. In other embodiments of the invention, sensitized peripheral surface 120 may be configured to detect not only feet motion, but body motion as well, including hand motion. In other embodiments of the invention, sensitized peripheral surface 120 may be comprised of any type of sensing technology.

Sensitized peripheral surface 120 may be configured to allow multiple individuals to use sensitized peripheral surface 120, simultaneously. In one embodiment of the invention as shown in FIG. 1, each side of interactive video floor 110 may contain a segment of sensitized peripheral surface 120, for a total of four segments as shown in FIG. 1. Each segment of sensitized peripheral surface 120 may be further partitioned into four sections and an individual may stand in each section. Each section of a segment of sensitized peripheral surface 120 may be equipped with the sensitized controls that an individual may step onto in order to interact with graphical display shown on interactive video floor 110. The sensitized controls of each section may be configured into various formats depending on the nature of the interactive content programmed into interactive computer 140. Essentially, each sensitized control provides an individual with the control interface to interact with the graphical contents displayed on interactive video floor 110. For example, if a videogame may be displayed through interactive video floor 110 and this videogame involves racing a virtual racecar though a virtual racetrack, then sensitized controls may be digitally configured by interactive computer 140 to represent a directional pad for left and right turns, an acceleration controller, a break controller and a gear-shifting controller. Each section's sensitized controls may allow an individual to drive a racecar across interactive video floor 110. In another example, the interactive video floor 110 may comprise of a videogame where the user must shoot at targets travelling across interactive video floor 110. The sensitized controls for this videogame may be digitally configured to comprise a directional control pad for aiming at targets travelling across interactive video floor 110 and a shoot pad for shooting at the target. The sensitized controls on sensitized peripheral surface 120 may be configured to accommodate the controls required for various videogame.

Ramp 125 may be attached to sensitized peripheral surface 120. In one embodiment of the invention as shown in FIG. 1, ramp 125 is designed to allow individuals to walk up to and onto sensitized peripheral surface 120. Both interactive video floor 110 and sensitized peripheral surface 120 are slightly above ground level and horizontal to the ground level due to connection with ramp 125. Ramp 125 is slightly slanted upwards from ground level to level of sensitized peripheral surface 120. The space underneath interactive video floor 110 and sensitized peripheral surface 120 may be used to store hardware related to this invention.

In one embodiment of the invention as shown in FIG. 1, user interaction with sensitized peripheral surface 120 may be translated into digital input data that may be transmitted to interactive computer 140 through physical connections such as network wires. In other embodiments of the invention, the connection mechanism between sensitized peripheral surface 120 and interactive computer 140 may take on any form, such as wireless connection.

In one embodiment of the invention as shown in FIG. 1, interactive computer 140 may control the contents displayed on interactive video floor 110. Interactive computer 140 may be physically detached from interactive video floor 110 and interactive computer 140 may be stored elsewhere. Interactive computer 140 may communicate with interactive video floor 110 and sensitized peripheral surface 120 through wired or wireless connection. Interactive computer 140 may contain software that displays interactive graphical applications, videogames, or any other interactive graphical program. Software may be programmed directly into interactive computer 140 or downloaded onto interactive computer 140. In other embodiments of the invention, connection between interactive computer 140 and interactive video floor 110 and sensitized peripheral surface 120 may be achieved through any type of network system setup.

Interactive computer 140 may receive continuous digital input data from sensitized peripheral surface 120 due to user interaction with sensitized peripheral surface 120. The digital input data may be processed within interactive computer 140 and the resulting digital output data, affecting the display on interactive video floor 110, may be transmitted back to interactive video floor 110. The digital output data may comprise, in addition to graphical data, sensitized peripheral data and audio data. In one embodiment of the invention as shown in FIG. 1, interactive computer 140 may transmit sensitized peripheral data to sensitized peripheral surface 120 to reconfigure the sensitized controls within sensitized peripheral surface 120. For example, different videogames programmed into interactive computer 140 may configure sensitized controls on sensitized peripheral surface 120 differently. Interactive computer 140 may be programmed to reconfigure the sensitized controls on sensitized peripheral surface 120 to suit changing needs of different videogames, including changing the number of available sensitized controls on sensitized peripheral surface 120.

In one embodiment of the invention as shown in FIG. 1, audio data may be broadcasted through speakers located within interactive video floor 110 and/or within sensitized peripheral surface 120. In other embodiments of the invention, audio data may be broadcasted through external audio speakers through any type of wireless connection between interactive computer 140 and external audio speakers.

In one embodiment of the invention as shown in FIG. 1, interactive computer 140 may transmit digital output data to interactive video floor 110 through video system 130. Video system 130 may receive digital output data from interactive computer 140 and may distribute digital output data back to interactive video floor 110 and to sensitized peripheral surface 120. Since interactive video floor 110 may comprise multiple LCD display monitors, video system 130 ensures that proper graphical information in digital output data is distributed to proper LCD monitors within interactive video floor 110. In other embodiments of the invention, all exchange of digital data between interactive video floor 110 and interactive computer 140 may go through video system 130. In yet other embodiments, exchange of data between interactive computer 140 and sensitized peripheral surface 120 may also take place through video system 130.

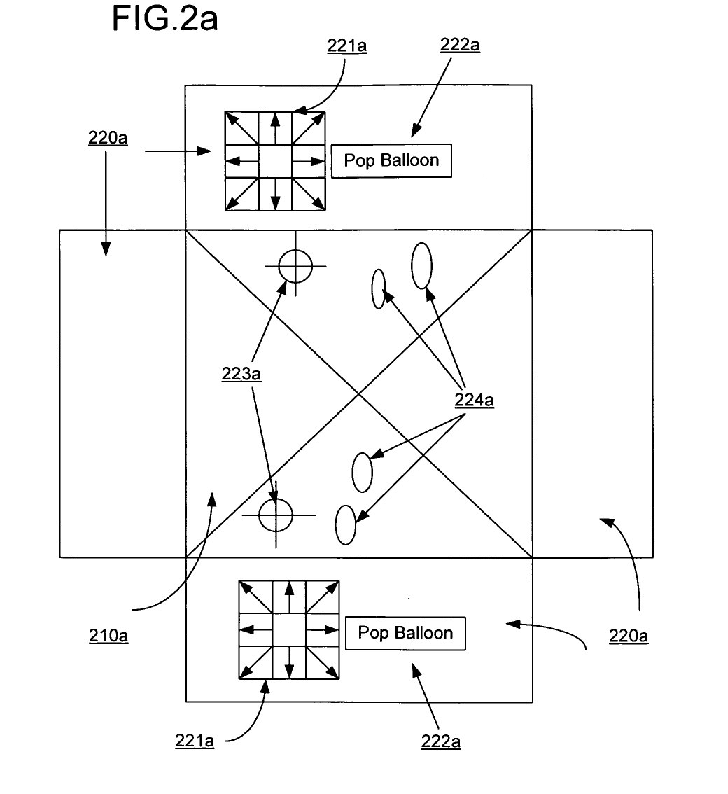

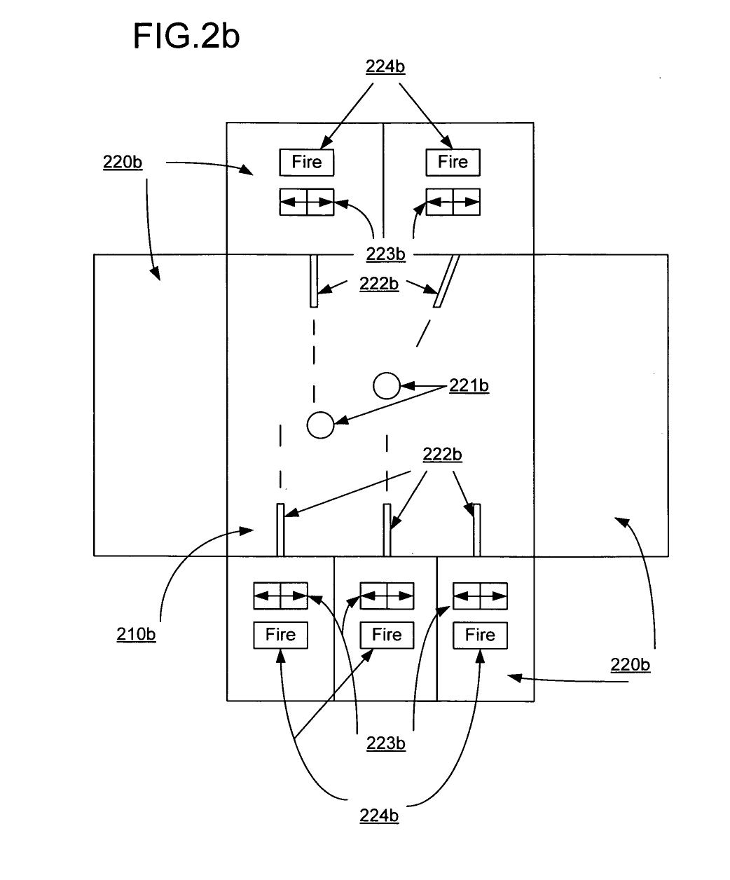

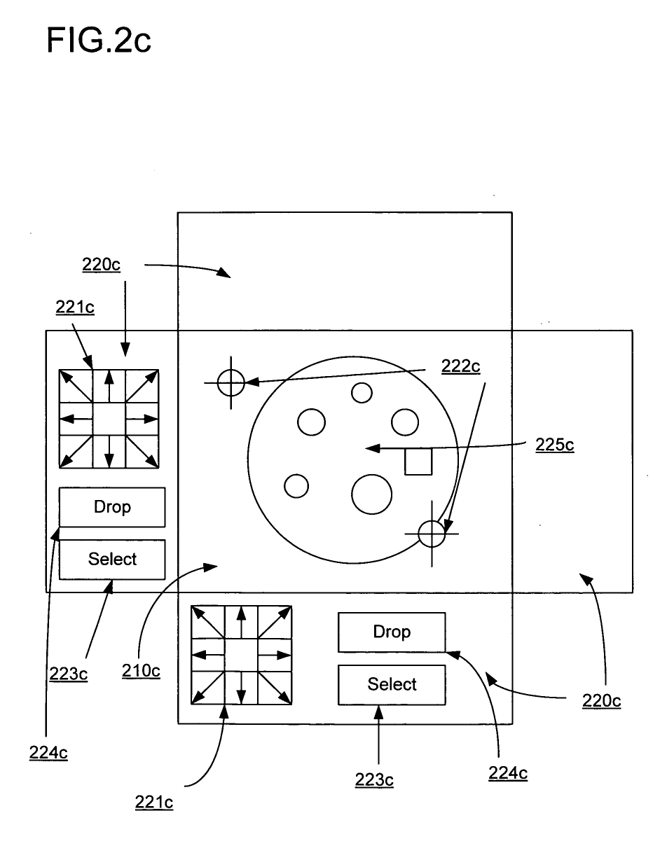

Moving to FIG. 2a, FIG. 2b and FIG. 2c, FIG. 2a, FIG. 2b and FIG. 2c presents three instances of interactive display floor with multi-touch surround surfaces, according to one embodiment of the present invention. FIG. 2a includes interactive video floor 210a, sensitized peripheral surface 220a, directional pad 221a, pop balloon button 222a, crosshairs 223a and balloons 224a. FIG. 2b includes interactive video floor 210b, sensitized peripheral surface 220b, indestructible round objects 221b, disc cannon 222b, two directional buttons 223b and fire button 224b. FIG. 2c includes interactive video floors 210c, sensitized peripheral surfaces 220c, directional pad 221c, crosshairs 222c, select button 223c, drop button 224c and pizza 225c. Interactive video floors 210a through 210c may each correspond to interactive video floor 110 in FIG. 1, and sensitized peripheral surfaces 220a through 220c may each correspond to sensitized peripheral surface 120 in FIG. 1.

Interactive video floor 210a in FIG. 2a is an alternative embodiment of interactive video floor 110 in FIG. 1. Interactive video floor 210a may display the contents of a balloon popping videogame that may involve one or more players working together in a team and that team may compete against other teams. In one embodiment of an interactive balloon popping videogame as shown in FIG. 2a, many balloons 224a may spawn within interactive video floor 210a. Interactive video floor 210a may be separated into four triangular areas by two diagonal lines across opposite corners of the rectangular screen as shown in FIG. 2a. Randomly generated balloons 224a may slowly drift towards the edges surrounding interactive video floor 210a but those balloons 224a may not drift into adjacent areas. If not popped by the players, these balloons 224a may reach the edges of interactive video floor 210a. Each player or players within an area may cooperate together as a team to try to pop all floating balloons 224a in that area by setting the target or targets onto balloons 224a to pop and by stepping on the light pad to pop those balloons 224a.

Every player on sensitized peripheral surface 120 may be given access to directional pad 221a used to move crosshairs 223a upon any drifting balloons 224a within the corresponding area, and pop balloon button 222a to pop any targeted balloons 224a in Diagram 200 of FIG. 2. Balloons 224a that successfully drifts to an edge of interactive video floor 210a may be counted against the team occupying that side of interactive video floor 210a. Balloons 224a may spawn within any of the four areas within interactive video floor 210a, but those spawned balloons 224a may only drift within the area they are spawned within. At the end of the videogame match the side of interactive video floor 210a with least number of balloons 224a having reached that side wins.

Interactive video floor 210b of FIG. 2b is an alternative embodiment of interactive video floor 110 in FIG. 1. Interactive video floor 210b may display the graphical contents of a multi-team disc shooting and defending videogame. In this videogame, teams of up to four individuals per team may be pitted against each other with the goal of shooting one or more indestructible round object 221b floating across interactive video floor 210b into the side of another team with ammunition from a disc cannon 222b. When indestructible round objects 221b are hit with ammunition fired from a disc cannon 222b, indestructible round objects 221b may be pushed into the direction the ammunition is traveling. In order to win this videogame, a team may try and force as many indestructible round objects 221b to collide into opponent team's occupied edge of interactive video floor 210b. Each team's members may occupy one whole side of the interactive video floor 110 in FIG. 1. Each team that fails to prevent a pre-determined number of indestructible round object 221b from reaching its side may have all of its members eliminated from participating in such a game, and all remaining teams may continue to compete until only one team remains. Indestructible round objects 221b that collide an edge of interactive video floor 220b may be removed from the videogame. Interactive computer 140 from FIG. 1 is programmed to randomly introduce new indestructible round objects 221b. In one embodiment of this videogame as shown in FIG. 2b, there are two teams competing against each other. One team may contain three players located on a segment of sensitized peripheral surface 220b, and another team with two players.

Each player has a disc cannon 222b displayed on interactive video floor 210b which may be rotated from aiming left to aiming right by using two directional buttons 223b each player has. Each player also has a fire button 224b to contact with in order to fire disc cannon 222b ammunition at indestructible round objects 221b. In FIG. 2b, there may be a couple of indestructible round objects 221b traveling across interactive video floor 210b but there may be more or less indestructible round objects 221b in other games. The other two segments of sensitized peripheral surface 220b are blank because no players have chosen to occupy those two segments of sensitized peripheral surface 220b. When a segment of sensitized peripheral surface 220b contains no players, indestructible round objects 221b may bounce off of that edge corresponding to that segment of sensitized peripheral surface 220b.

Interactive video floor 210c of FIG. 2c is an alternative embodiment of interactive video floor 110 in FIG. 1. Interactive video floor 210c is displaying the contents of a pizza 225c creation videogame. In this videogame, up to four teams may cooperate with each other in order to create a pizza 225c with various virtual toppings. There may be two modes available in this embodiment of the videogame. The first mode may be creating a pizza 225c with randomly selected toppings during a period of time. In the second mode to this game, a player may place only appropriate pre-selected toppings onto the pizza 225c. The pre-selected toppings may be determined by interactive computer 140 shown in FIG. 1. When pre-selected toppings are displayed on interactive video floor 210c, the player may select that topping and may place that topping onto the virtual pizza 225c using directional pad 221c.

The controls for the pizza 225c creation videogame may be located on sensitized peripheral surface 220c. In one embodiment of the pizza 225c creation videogame as shown in FIG. 2c, two segments of sensitized peripheral surface 220c may be in use, indicating two individual players of this videogame. Within each segment of sensitized peripheral surface 220c, one set of sensitized controls may be created for each individual player. The sensitized controls may comprise of a directional pad 221c and two buttons. Directional pad 221c may allow the player to control crosshairs 222c. The player may place toppings at the locations of crosshairs 222c. The locations of crosshairs 222c may be changed with directional pad 221c. Select button 223c on sensitized peripheral surface 220c may allow the player to scroll through a list of toppings available in the current session of the videogame. Drop button 224c on sensitized peripheral surface 220c may allow a player to place currently selected topping at locations of crosshairs 222c.

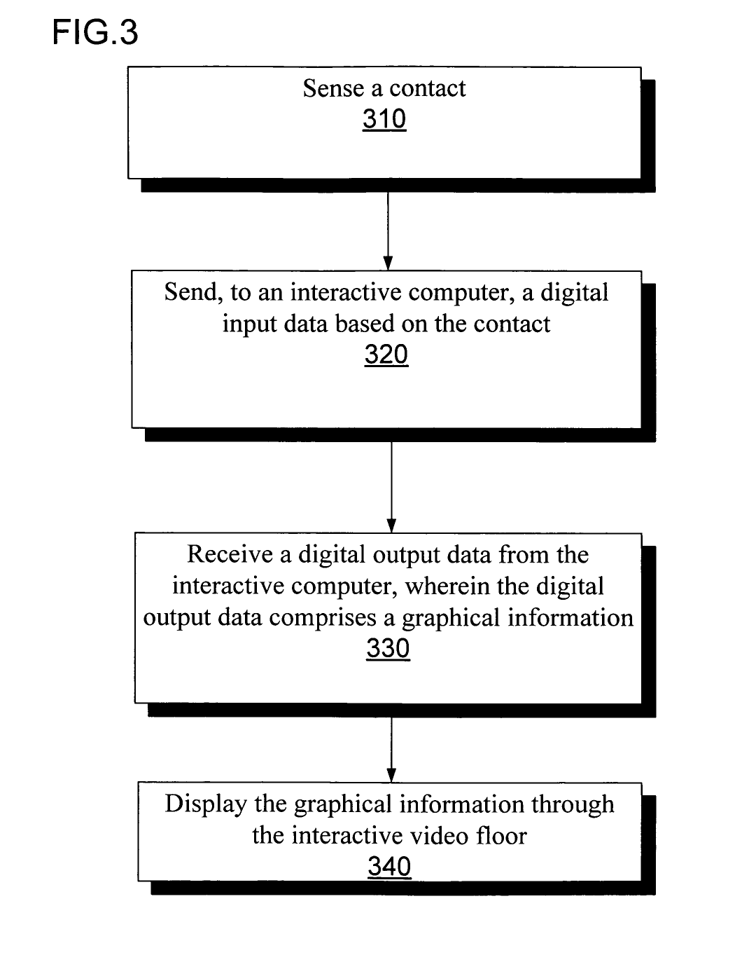

Moving to FIG. 3, FIG. 3 shows a flowchart describing the steps, according to one embodiment of the present invention, by which the interactive display floor with multi-touch surround surfaces may be provided. Certain details and features have been left out of flowchart 300 that are apparent to a person of ordinary skill in the art. For example, a step may comprise one or more substeps or many involve specialized equipment or materials, as known in the art. While steps 310 through 340 indicated in flowchart 300 are sufficient to describe one embodiment of the present invention, other embodiments of the invention may utilize steps different from those shown in flowchart 300.

Referring to step 310 of flowchart 300 in FIG. 3 and diagram 100 of FIG. 1, step 310 comprises sensitized peripheral surface 120 sensing a contact by a user with sensitized peripheral surface 120. Thus, the user may touch the sensitized peripheral surface 120 with his hands, feet or other objects, which is then stored as digital input data by the sensitized peripheral surface 120. In other embodiments of this invention, contact might not be direct physical contact. Motion of any body parts on top of sensitized peripheral surface 120 may be considered a contact.

Referring to step 320 of the flowchart 300 in FIG. 3 and diagram 100 of FIG. 1, step 320 comprises sensitized peripheral surface 120 sending digital input data to interactive computer 140 after converting the contact from step 310 into digital input data. Step 320 occurs immediately after step 310. Digital input data may be generated from sensitized peripheral surface 120 due to user contact in step 310. Digital input data may be transmitted from the sensitized peripheral surface 120 to interactive computer 140.

Referring to step 330 of the flowchart 300 in FIG. 3 and diagram 100 of FIG. 1, step 330 comprises interactive computer 140 and sensitized peripheral surface 120 based on the digital input data sent after step 320. After receiving digital input data in step 320, interactive computer 140 may process the digital input data and interactive computer 140 may generate a display output data to be transmitted back to sensitized peripheral surface 120.

Referring to step 340 of the flowchart 300 in FIG. 3 and diagram 100 of FIG. 1, step 340 comprises sensitized peripheral surface 120 and interactive video floor 110. Digital output data received by sensitized peripheral surface 120 in step 330 may contain graphical information that may be displayed on the interactive video floor 110.

From the above description of the invention it is manifest that various techniques can be used for implementing the concepts of the present invention without departing from its scope. Moreover, while the invention has been described with specific reference to certain embodiments, a person of ordinary skills in the art would recognize that changes can be made in form and detail without departing from the spirit and the scope of the invention. As such, the described embodiments are to be considered in all respects as illustrative and not restrictive. It should also be understood that the invention is not limited to the particular embodiments described herein, but is capable of many rearrangement, modifications, and substitutions without departing from the scope of the invention.

What is claimed is:

1. A method for use by a sensitized peripheral surface to provide interaction with an interactive display floor, the method comprising:
sensing a contact;
sending, to an interactive computer, a digital input data based on the contact;
receiving a digital output data from the interactive computer, wherein the digital output data comprises a graphical information; and
displaying the graphical information through the interactive video floor.

2. The method of claim 1 further comprising for use by the sensitized peripheral surface to provide interaction with an interactive display floor, the method further comprising configuring various sensitized controls based on the digital output data, wherein the digital output data comprises a sensitized peripheral data.

3. The method of claim 1 further comprising for use by the sensitized peripheral surface to provide interaction with an interactive display floor, the method further comprising broadcasting the digital output data information received from the interactive computer, wherein the digital output data comprises an audio signal information.

4. The method of claim 1, wherein the sensitized peripheral surface comprises a capacitive multi-touch LED display panel.

5. The method of claim 1, wherein the sensitized peripheral surface is configured to display at least one control wheel for navigating a digital racecar through a digital racetrack on the interactive video floor.

6. The method of claim 1, wherein the sensitized peripheral surface is configured to display at least one directional pad and button for aiming and shooting a digital weapon at a digital object on the interactive video floor.

7. The method of claim 1, wherein the sensitized peripheral surface is configured to display at least one directional pad and button for placing pizza toppings on top of a pizza on the interactive video floor.

8. The method of claim 1, wherein the sensitized peripheral surface is configured to display at least one directional pad and button for popping balloons on the interactive video floor.

9. The method of claim 1, wherein the sensitized peripheral surface is configured to display at least one directional pad and button for moving numerous puzzles pieces on the interactive video floor.

10. The method of claim 1, wherein the sensitized peripheral surface is configured to detect foot stomping and foot sweeping action for controlling a tongue of a frog used to catch insects.

11. A system for providing an interactive display floor, the system comprising:
an interactive video floor;
an interactive computer; and
a sensitized peripheral surface configured to:
sensing a contact;
send, to an interactive computer, a digital input data based on the contact;
receive a digital output data from the interactive computer, wherein the digital output data comprises a graphical information; and
display the graphical information through the interactive video floor.

12. The system of claim 11, wherein the sensitized peripheral surface is further configured to:
configure various sensitized controls based on the digital output data, wherein the digital output data comprises a sensitized peripheral data.

13. The system of claim 11, wherein the sensitized peripheral surface is further configured to:
broadcast the digital output data information received from the interactive computer, wherein the digital output data comprises an audio signal information.

14. The system of claim 11, wherein the sensitized peripheral surface comprises a capacitive multi-touch LED display panel.

15. The system of claim 11, wherein the sensitized peripheral surface is configured to display at least one control wheel for navigating a digital racecar through a digital racetrack on the interactive video floor.

16. The system of claim 11, wherein the sensitized peripheral surface is configured to display at least one directional pad and button for aiming and shooting a digital weapon at a digital object on the interactive video floor.

17. The system of claim 11, wherein the sensitized peripheral surface is configured to display at least one directional pad and button for placing pizza toppings on top of a pizza on the interactive video floor.

18. The system of claim 11, wherein the sensitized peripheral surface is configured to display at least one directional pad and button for popping balloons on the interactive video floor.

19. The system of claim 11, wherein the sensitized peripheral surface is configured to display at least one directional pad and button for moving numerous puzzles pieces on the interactive video floor.

20. The system of claim 11, wherein the sensitized peripheral surface is configured to detect foot stomping and foot sweeping action for controlling a tongue of a frog used to catch insects.
